(19) United States
(12) Patent Application Publication
(10) Pub. No.: US 2018/0249711 A1
(43) Pub. Date: Sep. 6, 2018

(54) COMPOSITIONS AND METHODS OF USE PERTAINING TO INSECTICIDE

(71) Applicants: Elias Rosen, Brooklyn, NY (US); Matthew Sabatino, Brooklyn, NY (US)

(72) Inventors: Elias Rosen, Brooklyn, NY (US); Matthew Sabatino, Brooklyn, NY (US)

(21) Appl. No.: 15/973,350

(22) Filed: May 7, 2018

Related U.S. Application Data
(62) Division of application No. 13/382,977, filed on Aug. 22, 2012.
(60) Provisional application No. 61/224,380, filed on Jul. 9, 2009.

(51) Int. Cl. A01N 41/02; A01N 25/00

(52) U.S. Cl. CPC A01N 41/02; A01N 2300/00; A01N 25/006

(57) ABSTRACT

The invention provides an aqueous insecticide comprised of at least one surfactant, a preservative, e.g., preservative, for example a potassium salt, sodium chloride in proportions similar to proportions normally detected in mammalian blood, a nutrient source, an organic acid capable of lowering the pH of the aqueous insecticide, fragrance, and water, for the control of Cimex, e.g., Cimex lectularius (bed bugs).

The present invention claims priority to U.S. Provisional Application No. 61/224,380, filed Jul. 9, 2010, the contents of which are incorporated by reference

### TECHNICAL FIELD

The invention relates to insecticidal compositions useful to control insects of the genus Cimex, particularly Cimex lectularius, commonly known as the “bed bug”; and more specifically to the field of “organic” or “natural” insecticides used to effectively eradicate Cimex species, and their eggs, in either an industrial or home setting. The field also relates to the methods of using same insecticides to control Cimex species and their eggs in either an industrial or personal application.

### BACKGROUND OF THE INVENTION

Once thought to be nearly eradicated, parasitic infestations of Cimex lectularius, more commonly known as the “bedbug,” have risen dramatically in recent years thus prompting public health concerns due to this observed escalation. Consequently, it has become increasingly desirable to develop insecticides able to specifically address the unique nature of bed bug infestations.

Concomitant with the dilemma of increased bedbug infestations has been the rise in consumer demand for insecticides that are not only effective in eliminating insect colonies but are both safe and minimally harmful to the environment. It is common for commercially available products to contain highly toxic ingredients that are harmful not only to the targeted insects, but to the user, or any individual who happens to be exposed. For example, such commercial insecticides, despite their reported efficacy, may pose certain health risks, such as headaches resulting from the inhalation of fumes. Coupled with these human health risks is the concern that these commercially available insecticides may be unduly harming the environment, and there are attendant concerns relating to their use and disposal. Such safety concerns have therefore prompted increased consumer demand relating to insecticides that are far less toxic with regards to any environmental impact they may have.

However, despite this overwhelming need to produce an insecticide that is at once both efficacious in eradicating bedbug infestations, as well as being far less toxic than what is currently commercially available, very few products have thus far been reported to successfully combine these benefits. Products that have disclosed the use of less toxic ingredients have typically had limited efficacy with regards to decreasing insect populations. Products made up of “non-toxic” or “natural” compounds have generally failed to address the specific and unique issues relating to bed bug infestations:

U.S. Pat. No. 6,548,085: “Insecticidal Compositions and Method of Controlling Insect Pests Using Same” discloses, for example, the use of “non-poisonous” chemicals. However, this particular invention has focused its primary use on various species of cockroaches, ants, and soft-bodied flying insects such as mosquitoes.

U.S. Pat. No. 6,231,865: “Natural Pesticide,” discloses the combination of citrus oils and garlic oils for use in an agricultural setting to protect certain plants from various forms of fungi and bacteria. Thus, the issue of bedbug infestation was bypassed completely.

U.S. Pat. No. 6,103,763: “Methods of Killing Insects,” discloses that sodium lauryl sulfate does offer some limited efficacy in treating aphids, killing the nymphs but merely delaying death in the adults; although that reference points out that it is actually sodium dioctyl sulfosuccinate which is the primary compound responsible for the observed insecticidal activity.

There are “natural” insecticides that utilize surfactants. However, the surfactant content of these products is generally much higher than the present invention. Moreover, these products have limited effectiveness against hard bodied insects, being useful generally for control of insects with soft-bodies, such as mosquitoes.

### SUMMARY OF THE INVENTION

The primary purpose of this invention is to provide a safe, natural, highly efficacious, aqueous insecticide that is specifically designed to provide immediate eradication of infestations of Cimex lectularius, also known as the common bedbug. An advantage of the invention is that the targeted insects do not develop any type of immunity to the insecticidal activity of the compound.

In one example, the invention is an aqueous insecticide comprised of at least one surfactant, a preservative, e.g., preservative, for example a potassium salt, sodium chloride in proportions similar to proportions normally detected in mammalian blood (e.g., human blood), a nutrient source, an organic acid capable of lowering the pH of the aqueous insecticide, fragrance, and water.

The aqueous insecticide of this invention is specifically designed to more efficiently control Cimex, e.g., Cimex lectularius. For example, the bedbug possesses a hard outer exoskeleton which protects the bed bug from conventional insecticides.

Without intending to be bound by theory, it is believed that the compounds and ingredients of the aqueous insecticide work first at the point of the exoskeleton itself, acting primarily as a means to disrupt the bed bug's waxy exoskeleton. It is believed that due to the presence of nutrients and salt, the adult bed bug will consume the composition. This allows the surfactant to disrupt the gastric surfaces of the bed bug, and also to disrupt the pores and more vulnerable areas between the plates of the bed bug's exoskeleton, which are exposed when the bed bug swells after feeding. The compositions of the invention are therefore effective even with lower surfactant concentrations than in previous products used to eradicate soft-bodied insects, mosquitoes, for example.

### DETAILED DESCRIPTION OF THE INVENTION

The examples provided in the detailed description are merely examples, which should not be used to limit the scope of the claims in any claim construction or interpretation.

In one example, Composition I is an aqueous composition consisting of, consisting essentially of and/or comprising:
a) a surfactant, at a level which may be sufficient to operate as an solubilizing agent;
b) a preservative, e.g., a potassium salt, at a level which may be sufficient to prevent the growth of microorganisms resulting from the presence of said surfactant;
c) sodium chloride or other compounds present in mammalian blood, at a concentration comparable to that which is found in mammalian blood;
d) a nutrient source, wherein the nutrient source may operate to attract the insects into one general location;
e) an organic acid, wherein the organic acid may operate to lower the pH of the aqueous insecticide to a level which preserves the nutrient source; and
f) water.

The invention thus provides the following Compositions:

1.1 Composition 1 wherein the surfactant is an anionic surfactant having a high water solubility;
1.2 Composition 1 or 1.1 wherein the surfactant is sodium lauryl sulfate;
1.3 Composition 1, 1.1 or 1.2 wherein the amount of surfactant in the composition is, e.g. 1-10% by weight, e.g., 2% to 9%, 3.5% to 8.0%, about 4% or 4.1% relative to the weight of the composition;
1.4 Any of the foregoing compositions wherein the preservative is sorbic acid and/or a salt of sorbic acid, i.e., sodium sorbate, potassium sorbate, and/or calcium sorbate, or a mixture thereof;
1.5 Any of the foregoing compositions wherein the preservative is the range of about 0.1% to about 1%, e.g., 0.1% to 0.5%, 0.2% to 0.4%, or about 0.25% or 0.27% relative to the weight of the aqueous insecticide;
1.6 Any of the foregoing compositions wherein the nutrient source comprises a simple carbohydrate;
1.7 Any of the foregoing compositions wherein the nutrient source comprises a simple carbohydrate produced by the yeast which is comprised within the aqueous insecticide;
1.8 Any of the foregoing compositions wherein the organic acid capable of lowering the pH of the aqueous insecticide is acetic acid;
1.9 Any of the foregoing compositions wherein the final pH of the aqueous insecticide is less than 7, e.g., 4-6.5;
1.10 Any of the foregoing compositions wherein the water is distilled water;
1.11 Any of the foregoing compositions further comprising a fragrance;
1.12 Composition 1.11 wherein the fragrance comprises an essential oil;
1.13 Composition 1.12 wherein the essential oil is lemongrass oil;
1.14 Composition 1.12 or 1.13 wherein the essential oil is present in an amount of approximately 0.05% to about 0.3%, e.g., about 0.15% or 0.1% by weight relative to final weight of aqueous insecticide.
1.15 Any of the foregoing compositions comprising about 4.14% sodium lauryl sulfate, about 1.12% sodium chloride, about 0.27% potassium sorbate, yeast, acetic acid, fragrance, and distilled water;
1.16 Any of the foregoing compositions which lacks effective amounts of any additional insecticide;
1.17 Any of the forgoing compositions which is an aqueous insecticide;
1.18 Any of the forgoing compositions diluted with water in a volume/volume ratio of, e.g., 1:1, 1:2, 1:2.5; 1:3; 1:3.5, 1:4, 1:4.5, 1:5. 1:6, 1:7, 1:10, or 1:100.
1.19 A spray bottle containing a composition of any of Compositions 1-1.18.
1.20 A gel composition comprising a gelling agent and any one of compositions 1-1.18.

The invention further provides a method of controlling Cimex, e.g. Cimex lectularius, infestations (Method 1) comprising applying, e.g., spraying, a composition selected from any of Compositions 1-1.18 in the area of infestation. The method may for example comprise application of the composition once, or repeatedly, e.g., on consecutive days, e.g., at least three consecutive days, and/or repeating the application once or twice a week for at least one month. In one embodiment, the aqueous insecticide controls not only adults, but also the larvae and eggs. The aqueous insecticide may be applied repeatedly to objects frequently used by either humans or pets. Such areas include, but are not limited to, beds or upholstered furniture that are frequently contacted by humans or pets. The product may also be applied to bedding, clothing, and/or luggage to prevent the transfer of Cimex lectularius from the initially infested area to a secondary area.

The area, or object, that has been subject to treatment using the aqueous insecticide may be utilized for its normal function almost immediately after use of the aqueous insecticide. For example, a user may apply the aqueous insecticide to a bed, and then use that same bed only a short time after treatment. This provides an advantage over other available products where a user may be restricted from using the area that has been previously subject to treatment.

Still another advantage of the aqueous insecticide is the ability to localize individual bedbugs to a desired area using a nutrient source. Thus, once individual bedbugs are substantially closer to one another relative to their spatial proximity, there is an increased likelihood that all the insects that are a part of the infestation are then contacted with the insecticide. Such an advantage greatly decreases the likelihood of recurrent infestation. This represents an advantage over other types of “contact” insecticides that, while killing insects that are actually contacted, may simultaneously repel non-contacted insects; thus, complete eradication may be extremely difficult to achieve.

Yet another advantage is that the aqueous insecticide does not release toxic fumes which could then possibly be inhaled. As a result of this advantage there is no need to provide additional ventilation to the immediate area or room where the infestation is located and the insecticide is applied.

The compositions of the present invention may be dispensed, i.e., sprayed, on to materials to be treated by any number of methods known in the art. In one embodiment, the composition may be dispensed in a bottle that can squirt, spray or mist fluids, otherwise known as a spray bottle. In another embodiment, the composition may be pressurized in a container to be delivered as an aerosol spray. Such aerosol sprays are known to those of skill in the art.

The compositions of the present invention incorporate one or more surfactants which are known in the art. Suitable surfactants include those which are reasonably stable throughout a wide pH range, for example, anionic, cationic, nonionic or zwitterionic surfactants. In certain embodiments, anionic surfactants useful herein include the water-soluble salts of alkyl sulfates having about 10 to about 18 carbon atoms in the alkyl radical and the water-soluble salts of sulfonated monoglycerides of fatty acids having about 10 to about 18 carbon atoms. Sodium lauryl sulfate, sodium lauroyl sarcosinate and sodium coconut monoglyceride sulfonates are examples of anionic surfactants of this type. Mixtures of anionic surfactants may also be utilized.

The compositions of the present invention may utilize any one or combinations of organic acids. Suitable organic acids include malic acid, fumaric acid, tartaric acid, lactic acid, citric acid, and acetic acid. The organic acid may be added to the compositions of the present invention as a mixture of materials, such as present in vinegar when acetic acid is selected as the organic acid. Various types of vinegars may be used, especially food grade vinegars. The vinegars may also have colors or dyes, for example, red wine vinegar, apple cider vinegar, and/or balsamic vinegar. The particular vinegar selected for use in the composition is not critical, so long as the required amount of acetic acid is present in the final composition.

The amounts of sodium chloride normally detected in mammalian blood is known by those of skill in the art. For example the amount of sodium chloride present is isotonic with mammalian blood. In addition to sodium chloride, the compositions of the present invention may also contain other salts, ions and compounds which are also present in mammalian blood, e.g., human blood, such as lactate, potassium and calcium, which may be provided with appropriate amounts of sodium lactate, calcium chloride, and potassium chloride. In one embodiment, the amount of salt in the compositions of the present invention produce a solution which is substantially isotonic with mammalian blood, e.g., human blood, for example, as present in normal saline, Lactated Ringer's solution. Thus, the compositions of the present invention may comprise one or more of the following ions:
sodium ion at approximately 130 mmol/L;
chloride ion at approximately 109 mmol/L;
lactate ion at approximately 28 mmol/L;
potassium ion at approximately 4 mmol/L; and/or
calcium ion at approximately 1.5 mmol/L.

The nutrient source of the present invention may be a simply carbohydrate. The simple carbohydrate may be yeast, or compounds produced by yeast. Other nutrient sources may include any one or a combination of casamino acids, trypton, and/or yeast extract.

The compositions of the present invention may also contain one or more additional ingredients, such as a dye or color, and mammalian whole blood or blood components (such as plasma, red blood cells, hemoglobin, etc), such as from leporidae, canine, feline, bovine, porcine, murine, homo, and/or bovidae.

The compositions of the present invention, although previously described as a liquid, may also be prepared as a thixotropic fluid, or gel. In one embodiment, the insecticide of the present invention also comprises a gelling material, allowing for dispensing the insecticide composition as a solid gel, e.g., squeezed through a tube. Gel compositions are well known in the art, and may include hydrogels, organogels, or xerogels, all of which are known by those of skill in the art. Incorporation of the insecticide composition of the present invention in a gel is well within the ability of one of skill in the art.

When the compositions of the present invention are in the form of a gel, the gel may be dispersed, e.g., along the based of a wall, around the perimeter of a bed, along or around the base of a bed, along or around a bed box spring, or any other boundary where one would desire inhibiting Cimex lectularius from crossing over.

The materials required for the compositions of the present invention may be acquired from any number of commercially available sources, such as Sigma-Aldrich (St. Louis, Mo., US), Alpha Chem, Inc. (Lexington Mass., US), Fisher Scientific Company (Pittsburgh, Pa.), VWR International (West Chester, Pa., US), and Becton, Dickinson and Company (Franklin Lakes, N.J., US).

Also contemplate in the present invention is a method to prevent, treat, reduce the incidence, or reduce the risk of cimicosis on a mammal, e.g., human, comprising applying any of the compositions of the present invention to the skin or hair of the mammal.

### EXAMPLES

### Example 1

A concentrated composition of the present invention is prepared as follows:

Step 1: 19.2 oz of SLS is added to 2 gallons of water. The mixture is stirred and allowed to sit for at least 2 minutes, e.g., 10 minutes.
Step 2: 1.7 oz of potassium sorbate is added to 1 gallon of water. The mixture is stirred and allowed to sit for at least 2 minutes, e.g., 10 minutes.
Step 3: 7.1 oz of sodium chloride is added to 1 gallon of water. The mixture is stirred and allowed to sit for at least 2 minutes, e.g., 10 minutes.
Step 4: The solutions of Step 1, 2, and 3 are mixed together.
Step 5: 1 gallon of vinegar (5% acetic acid) is added to the mixture of Step 4.
Step 6: 3.2 oz, or 6 to 8 oz of lemongrass oil is added to the solution of Step 5.
Step 7. Add 2.5 oz of yeast to the solution of Step 6 and mix.

It may be appreciated the water utilized to dissolve the ingredients may have a temperature which is cold (e.g., less than 20° C.), room temperature (e.g., 20° C. to about 25° C.), warm (e.g., 25° C. to about 50° C., hot (e.g., 50° C. to about 99° C.), or boiling water (100° C. or greater). If the water temperature is warm, hot or boiling, such solutions may be allowed to sit until the solution reaches room temperature.

It may be appreciated the composition of Example 1 may be allowed to sit for a period of time, i.e., 1 hour, 6 hours, at least 12 hours, at least 24 hours, at least 2 days, at least 1 week, at least one or six months, or at least one year prior to dilution with water.

### Example 2

8 oz by volume of the composition of Example 1 is added to 24 oz water. The mixture is stirred.

As detailed in Examples 1 and 2, the compositions of the present invention are made in single batches. However, the compositions of the present invention may also be manufactured continuously, and batch sizes can be easily scaled up.

### Example 3

The composition of Example 2 is dispensed in a spray-type bottle. Cimex lectularius are observed on normal couch fabric. The composition of Example 3 is sprayed on to the Cimex lectularius at a distance of 12 inches, and will be killed. Death of Cimex lectularius may be verified and/or observed when the insects are observed to remain “standing on their head”. Death may be observed, i.e., 1 to 30 seconds after application, i.e., within 20 seconds, i.e., between 6 and 15 seconds.

### Example 4

Cimex lectularius are observed on a wooden surface of a bed box spring. The composition of example 2 dispensed in a spray-type bottle is applied to the Cimex lectularius. Death is observable between 3-6 seconds.

### Example 5

Cimex lectularius is observed on a carpet or rug. The composition of example 2 dispensed in a spray-type bottle is applied to the Cimex lectularius. Death is observable between 8-20 seconds.

### Example 6

Cimex lectularius is observed on clothing, either poly-blend and/or cotton. The composition of example 2 dispensed in a spray-type bottle is applied to the Cimex lectularius. Death is observable between 6-15 seconds.

### Example 7

Cimex lectularius is observed on sheetrock. The composition of example 2 dispensed in a spray-type bottle is applied to the Cimex lectularius. Death is observable between 3-6 seconds.

### Example 8

Cimex lectularius is observed on bedding. The composition of example 2 dispensed in a spray-type bottle is applied to the Cimex lectularius. Death is observable between 1-30 seconds.

### Example 9

Approximately 4.1 grams of SLS, 0.27 grams of potassium sorbate, 1 gram of sodium chloride, and 3 grams of yeast are mixed and packaged. The compositions of the package are added to approximately 100 g of water and mixed to yield an insecticide composition.

### Example 10

One gallon of the composition of Example 1 is mixed in a container with 2 to 4 gallons, e.g., 3 gallons of water. Fabrics contaminated with Cimex lectularius are added to the container and are allowed to be soaked for 1 hour, 12 hours, 1 day, or 2 days to treat the fabric in order to kill Cimex lectularius.

### Example 11

The composition of Example 1 is added to a laundry machine to wash fabrics.

1-15. (canceled)

16. A method of controlling Cimex infestations comprising applying an aqueous insecticide composition in the area of infestation, said aqueous insecticide composition comprising:
a) a surfactant;
b) a preservative;
c) sodium chloride;
d) a nutrient source;
e) an organic acid;
f) and water.

17. The method of claim 16 wherein the composition is applied at least three consecutive days

18. The method of claim 16 wherein the composition is applied at least two times a week for one month.

19. The method of claim 16, wherein contact by the aqueous insecticide operates to eradicate adult Cimex lectularius, larvae of Cimex lectularius, and eggs of same Cimex lectularius.

20. The method of claim 16, wherein the composition is applied using a spray pump or dispenser.

21. The method of claim 16, wherein the surfactant is an anionic surfactant with a high water solubility.

22. The method of claim 16, wherein the surfactant is sodium lauryl sulfate.

23. The method of claim 16, wherein the amount of surfactant in the composition is 1-10% by weight.

24. The method of claim 16, wherein the preservative is potassium sorbate.

25. The method of claim 16, wherein the preservative is the range of about 0.20% to 0.30% relative to the weight of the aqueous insecticide.

26. The method of claim 16, wherein the nutrient source comprises yeast.

27. The method of claim 16, wherein the organic acid capable of lowering the pH of the aqueous insecticide is acetic acid.

28. The method of claim 16, wherein the final pH of the aqueous insecticide is less than 7.

29. The method of claim 16, further comprising a fragrance.

30. The method of claim 16, wherein the fragrance comprises an essential oil.

31. The method of claim 30, wherein the essential oil is lemongrass oil.

32. The method of claim 30, wherein the essential oil is present in an amount of approximately 0.05% to about 0.30%.

33. The method of claim 16, comprising about 4.14% sodium lauryl sulfate, about 1.12% sodium chloride, about 0.27% potassium sorbate, yeast, acetic acid, fragrance, and distilled water.
